(19) United States
(12) Patent Application Publication
(10) Pub. No.: US 2008/0104507 A1
(43) Pub. Date: May 1, 2008

(54) Web page dependent browser menu

(75) Inventor: Mikko Nurmi, Tampere (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/591,036

(22) Filed: Oct. 31, 2006

(51) Int. Cl. G06F 17/00

(52) U.S. Cl. 715/255; 715/246; 715/243

(57) ABSTRACT

A web page is electronically retrieved from a remote site such as a server, using a web browser program. At a graphical display interface is simultaneously displayed a browser toolbar of menu items, at least a portion of the retrieved web page, and at least one pre-selected element of the web page. The pre-selected element is displayed at a new position different from an original position in which the pre-selected element exists in the retrieved web page. In an embodiment, the pre-selected element is a login block and the new position is within the toolbar. Methods, devices, embodied programs, and user interfaces are described.

### TECHNICAL FIELD

The exemplary and non-limiting embodiments of this invention relate generally to the graphical display of web pages as may be displayed in the context of a web browser program, and methods, computer programs and apparatus for displaying web pages as described herein.

### BACKGROUND

Internet browser programs are known in the art. Upon a command from a user, such as by selecting a hyperlink or an entry returned from a search engine, such browser programs return a web page that typically includes text and graphics arranged in a particular order relative to one another. Some web pages are designed to fit in their entirety on a desktop display screen, and others are too large and require the user to scroll in order to view the entire page.

Traditional web browsers and most web pages are designed for the context of a user's desktop computer environment, where the display screen generally measures at least fifteen inches diagonal. Once the web browser retrieves a web page requested by the user, it displays a menu of browser items and the web page together in a seamless view. Typically the menu items are a list of pull-down menu items displayed over the top of the returned web page, though some browsers enable the user to set the menu along the bottom or perhaps a side of the displayed web page. The menu items may include “file”, “edit” “view” “tools” “favorites” and “help”, typically configurable by a user to add items such as “mail” “search” “stop” “refresh” “back” and the like in the original menu bar or in a separate menu bar adjacent to the first.

The web page may include advertisements, which is considered herein as a graphical element of the web page because such an advertisement forms a part of the returned web page. However, many times a pop-up advertisement is also displayed. Such pop-up ads do not form a part of the web page because they are not “returned” as part of the web page itself as are embedded advertisements. The distinction between a pop-up and an embedded advertisement is evident in that a pop-up ad can be deleted from the display of the web-page without simultaneously deleting the returned web-page, whereas an advertisement embedded in the web page cannot be readily removed from the display apart from removing the web page entirely from the display (e.g., by changing the viewed web page, by minimizing its display to an icon, by exiting the web browser).

A problem arises with web pages that cannot be displayed in their entirety on a viewing screen. A user might desire to access a certain graphical element or other portion of the requested web page that is only viewable after scrolling. Whereas this problem is often minimal in a desktop computer environment with a large display screen and a robust link to the Internet, certain mobile computing devices, such as Internet enabled mobile phones, personal digital assistants (PDAs), and the like typically employ a display screen less than six inches diagonal, and their wireless nature makes the link to the Internet variable and not always as fast as the user might like. Scrolling on such a small screen requires more of the user's attention than a desktop environment, and where the network connection is less than optimal there may be a significant delay in downloading for display of the entire web page.

Whereas the advantages of the invention described below are most compelling for the mobile environment and small display screen as noted above, such are not limitations to the broader aspects of this invention, which may be practiced readily in the environment of a large display screen and/or a consistent and robust network link.

### BRIEF DESCRIPTION OF THE DRAWINGS

Exemplary embodiments of the present invention are detailed below with reference to the following drawing figures.

FIG. 1 shows a simplified block diagram of various electronic devices having a communication link to a network that are suitable for practicing the exemplary embodiments of this invention, and a simplified block diagram of such a device.

FIG. 2 is a more detailed view of components of a mobile station device suitable for practicing exemplary embodiments of the invention.

FIG. 3A is a ‘screen shot’ of a web page as displayed according to the prior art.

FIG. 3B is a ‘screen shot’ of a web page with the login box displayed in a framed web page, but without showing the browser toolbar.

FIG. 4A is a ‘screen shot’ of another web page as displayed according to the prior art.

FIG. 4B illustrates certain elements of the FIG. 4A web page in isolation that may be pre-selected by a user or web page content provider.

FIG. 4C illustrates the elements of FIG. 4B displayed with the prior art web page of FIG. 4A according to an embodiment of the invention.

### SUMMARY

In accordance with one exemplary embodiment of the invention is a method for displaying information. In the method, a web page is electronically retrieved from a remote site with a web browser program. At a graphical display interface is simultaneously displayed a browser toolbar of menu items, at least a portion of the retrieved web page, and at least one pre-selected element of the web page. The pre-selected element is displayed at a new position different from an original position in which the pre-selected element exists in the retrieved web page.

In accordance with one exemplary embodiment of the invention is a device that includes a memory, a processor, a graphical display interface, and a communication link. The memory is for storing computer programs including a web browser program. The processor is coupled to the memory and is for executing instructions of said computer programs. The graphical display interface is coupled to the processor and is for displaying information. The communication link is for coupling the device to the Internet. The web browser program and the processor operate to display at the graphical display interface, simultaneously, a browser toolbar of menu items, at least a portion of a web page (wherein the portion is displayed as retrieved from a remote site over the communication link), and at least one pre-selected element of the retrieved web page at a new position different from an original position in which the pre-selected element exists in the retrieved web page.

In accordance with one exemplary embodiment of the invention is a program of machine-readable instructions, tangibly embodied on an information bearing medium and executable by a digital data processor, to perform actions directed toward displaying information to a user. In this embodiment, the actions include electronically retrieving a web page from a remote site with a web browser program, and then displaying on a graphical display interface, simultaneously: a browser toolbar of menu items; at least a portion of the retrieved web page; and at least one pre-selected element of the web page at a new position different from an original position in which the pre-selected element exists in the retrieved web page.

In accordance with one exemplary embodiment of the invention is a device that includes memory means, processor means, graphical display means, means for communicating with a network, and means for coupling to a network. The memory means is for storing computer programs including a page display program such as a web browser program. The processor means is coupled to the memory means and is for executing instructions of said computer programs. The graphical display means is coupled to the processor means and is for displaying information. The page display program and the processor means operate to simultaneously display at the graphical display means at least a portion of an information page, retrieved from the network over the means for coupling, and at least one pre-selected element of the retrieved information page at a new position different from an original position in which the pre-selected element exists in the retrieved information page. In certain embodiments, the memory means includes a computer readable storage medium, the processor means includes a digital data processor, the graphical display means may be one of a display screen and a data projector, the means for communicating with a network may be one of a transceiver and a modem, and the means for coupling to a network comprises one of a wireless and a hardwired link.

In accordance with another exemplary embodiment is a user interface that has a graphical display interface. The graphical display interface is for simultaneously displaying at least a portion of a web page received over a wireless communication link, a browser toolbar from a local memory, and an element of the received web page. The element of the web page is displayed at a new position different than an original position in which the element is disposed in the received web page.

These and other embodiments are detailed further below.

### DETAILED DESCRIPTION

The exemplary embodiments of this invention provide a novel display of a web page that might be retrieved from a remote site such as an Internet server. Exemplary embodiments of the invention display the web page, as retrieved from the remote site, adjacent to a web browser menu and also with an element of the web page positioned at a location different from its original location, where the original location is the position within the original web page. The element or item of the web page may therefore be displayed twice in the same display: once in its original position and once as re-produced in its new position. In another view, it may be displayed only once as where the display shows only a portion of the web page (e.g., scrolling is required to view the remaining portions of the web page) and the re-produced element or item is visible while a portion of the web page that does not itself include that item is being displayed.

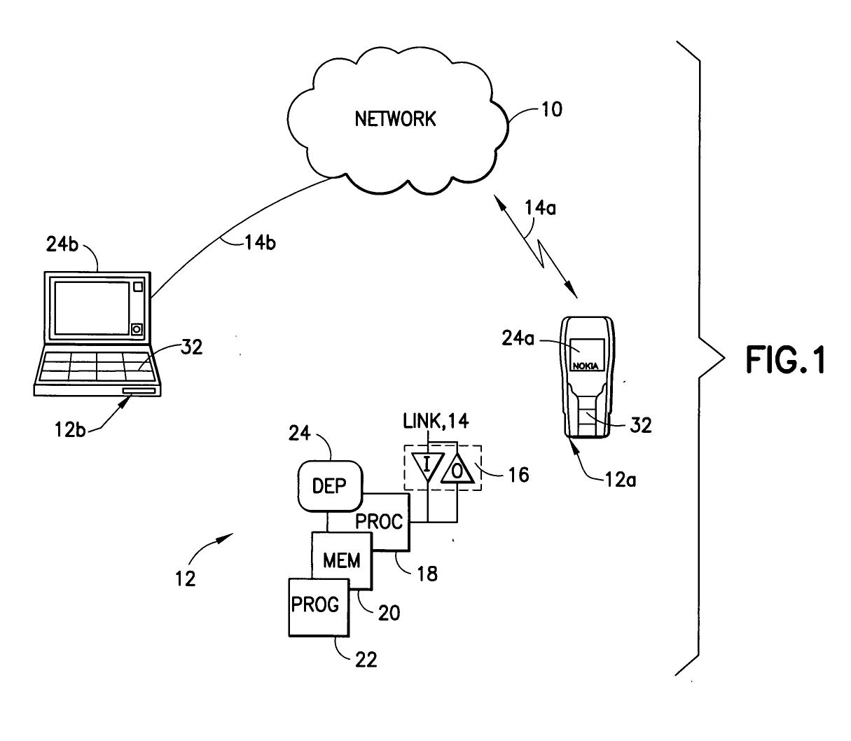

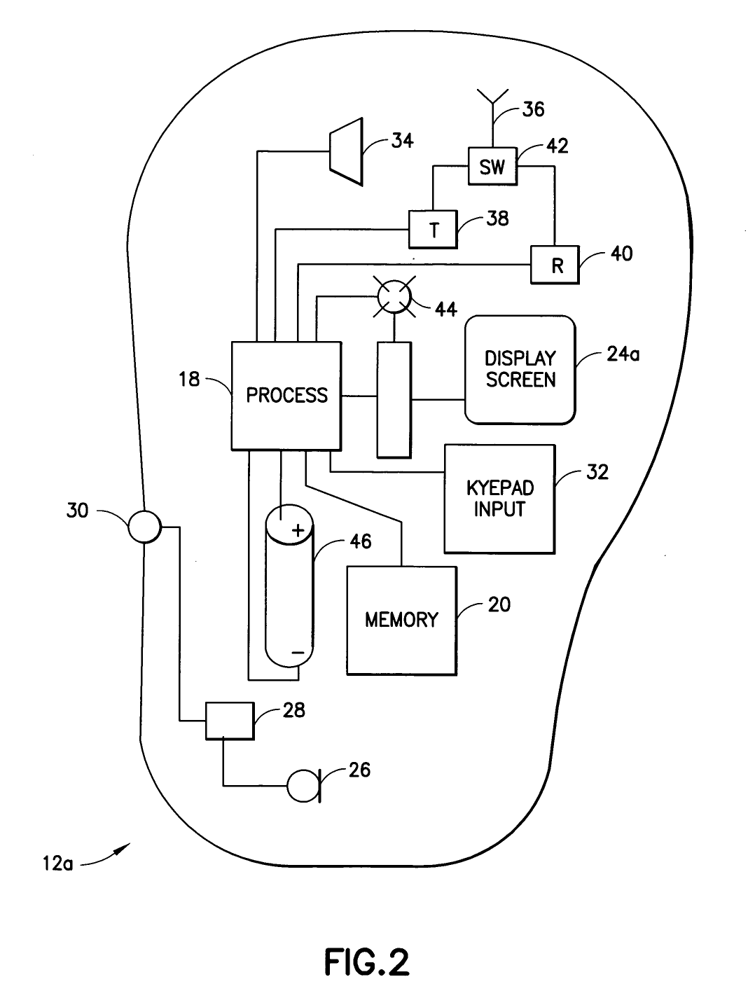

Reference is now made to FIG. 1 for illustrating a simplified block diagram of various electronic devices that are suitable for use in practicing the exemplary embodiments of this invention. In FIG. 1 a network 10 is adapted for communication with a device 12 such as a mobile station 12a or a personal computer PC 12b (laptop shown). In the case of a mobile station MS 12a, the network may include the Internet with servers coupled through a mobile telephony network, a WLAN, or a WiFi hotspot to communicate via a wireless link 14a with the MS 12a. The PC 12b may be similarly coupled, or may be coupled via a hardwire link 14b to a router or other Internet access point. In general, the device 12 will include a means for coupling 14 such as a wired or wireless communication link 14a, 14b; a means for communicating 16 such as a wireless transceiver or a modem; a processor (digital processor DP or digital signal processor DSP) 18, a memory 20 for storing computer program instructions 22 executable by the processor 18, and a means for displaying 24 such as a graphical display screen 24a, 24b, a projector (FIG. 2), or the like for visually presenting information to a user of the device 12. Various servers in the network are also assumed to include similar hardware and software for providing web pages to the devices 12 upon request.

FIG. 2 is a schematic block diagram of a MS 12a according to an embodiment of the present invention, though the various components of FIG. 2 may be embodied within a PC 12b, and/or may be adapted for the hardwired communication noted above and/or for a direct AC power supply. The MS 12a includes a microphone 26 coupled to the processor 18 through a buffer memory 28, and may also include a digital camera 30 for inputting live images digitally. Both the microphone 26 and the camera 30 are analog-to-digital transducers that serve to input data to the device 12a. The memory 20 may be magnetic, electronic, optical, or the like, and is for storing files, computer instructions, signal constellations and algorithms, and the like. The memory 20 may be one or several separate components, and may include both ROM and read-write RAM memory. The graphical display screen 24a and a keypad input 32 are also provided, and the graphical display screen 24a may be touch sensitive to also receive user inputs as is known in the art. The display screen 24a provides text and graphic information to a user, and the keypad input 32 may include buttons, soft keys with changeable functions, and dedicated keys such as power on and off. Images to the display screen 24a may be processed through a display driver 33, which is considered herein as being within the functional description of the processor. A frame memory typically associated with refreshing the display screen 24a is considered herein as within the memory 20, as the memory 20 as functionally described herein is not necessarily limited to a single memory component or to a singular location within the device 12. An output of the processor leads to a speaker 34 or other digital to analog transducer. One or more antennas 36 are coupled to the processor 18 through a transceiver, which includes a transmitter 38 and a receiver 40 coupled selectively to the antenna 36 through a dipole switch 42. Other transceiver arrangements are known in the art. A data projector 44 may be used in conjunction with or in place of the display screen 12a as a means to present information to a user, by projecting data onto a surface. Such a surface may be a part of the device 12a itself or may be a convenient surface that is separate and distinct from the MS 12a itself in order that the projected data is larger than the device and readily readable. In that regards, the projector 44 differs from the camera 30 in that it is a digital to analog transducer for outputting information, and serves as a graphical display interface. The various components of the device 12a are powered by a portable power source 46 such as a traditional galvanic battery.

In general, the various embodiments of the device 12 can include, but are not limited to, cellular telephones, personal digital assistants (PDAs) having wireless communication capabilities, portable computers having wired and/or wireless communication capabilities, gaming devices having wireless communication capabilities, Internet appliances permitting wireless Internet access and browsing, as well as terminals (portable or not) that incorporate combinations of such functions.

The embodiments of this invention may be implemented by computer software executable by the DP 18 of the device 12, or by hardware, or by a combination of software and hardware.

The memory 20 may be of any type suitable to the local technical environment and may be implemented using any suitable data storage technology, such as semiconductor-based memory devices, magnetic memory devices and systems, optical memory devices and systems, fixed memory and removable memory. The DP 18 may be of any type suitable to the local technical environment, and may include one or more of general purpose computers, special purpose computers, microprocessors, digital signal processors (DSPs) and processors based on a multi-core processor architecture, as non-limiting examples. The display means 24 may be a CRT screen, a flat panel display, a projector in combination with a designated screen or other surface, or any other means for generating a displayed image under command of the processor 18 and/or display driver 33.

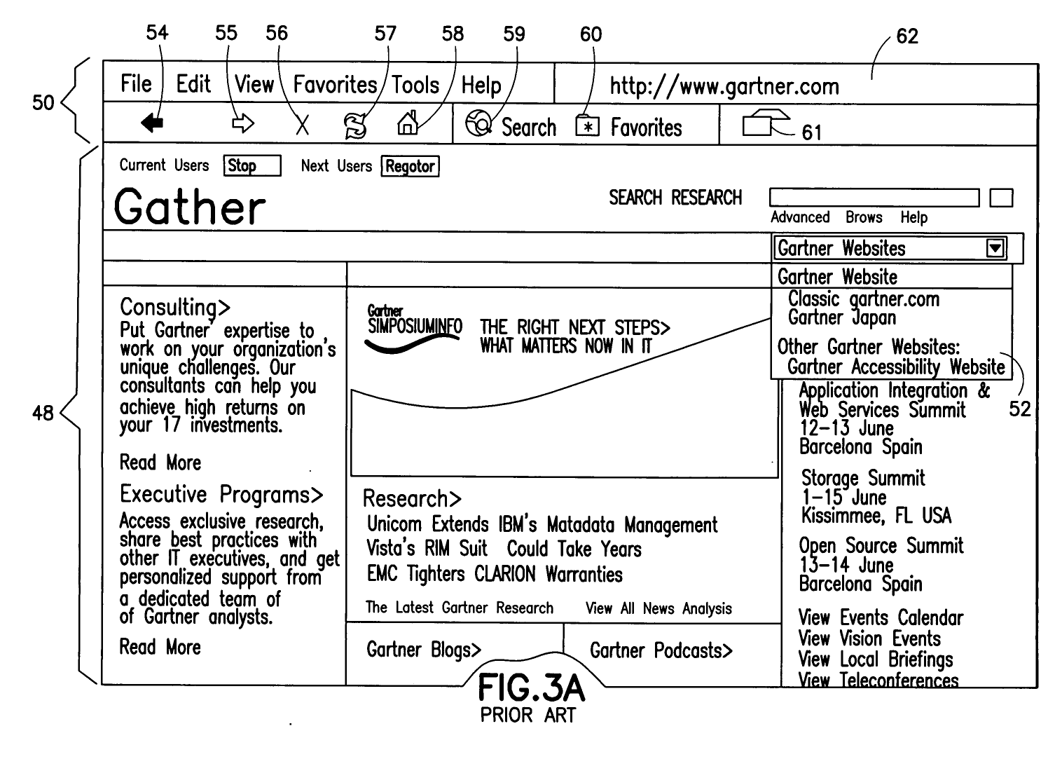

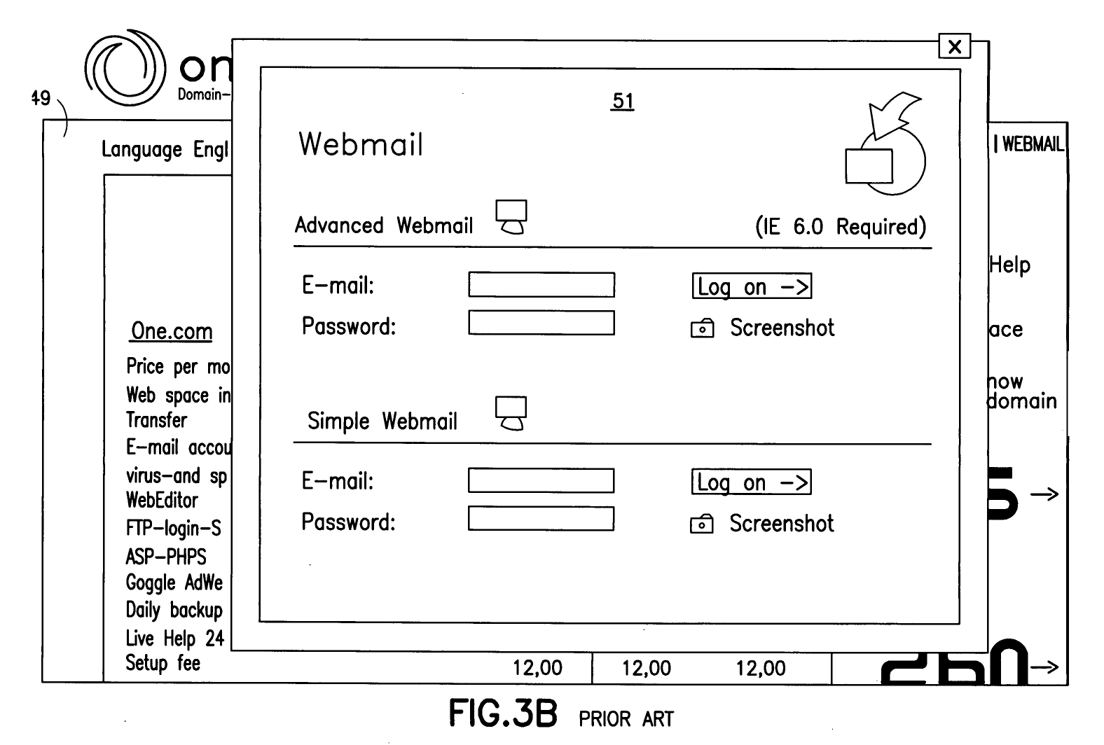

FIG. 3A illustrates a “screen shot” of a web page as displayed by a web browser program. A web browser program is a computer program that returns web pages requested by a user and that displays those pages as they are retrieved from a remote site, such as from a server on the Internet. FIG. 3A illustrates various elements that form the web page 48, 52, and any of the elements may have a graphical, text, or combination text and graphical components. As used herein, a retrieved web page is that web page as returned by the remote site that hosts the web page.

FIG. 3A also shows a traditional browser toolbar 50 disposed across the top of the web page. The toolbar 50 includes such commonly used icons or buttons as “back” 54, “forward” 55, “cancel” 56, “reload” 57, “home” 58, “search” 59, “favorites” 60, and “print” 61, as well as the current Internet address 62 of the web page and various pull down menu items (file, edit, view, etc.). That the toolbar may be configured by the user to add to or subtract from the illustrated icons/buttons, or may be displayed as a singular toolbar or multiple adjacent toolbars as shown, is not particularly relevant. Also displayed with the returned web page 48 is a web page element such as a drop-down menu 52.

According to an embodiment of this invention, the web page element 52 of FIG. 3A may be shown separately, in addition to the location illustrated in FIG. 3A which is an original location. This is advantageous in that, for a mobile device with a small display screen and in the event that a particular web page element 52 is not near the top of the overall web page so that it would not be shown on the mobile device display absent scrolling, a copy of the pre-selected web page element 52 can be artificially placed in a location where it would be displayed without scrolling. If the pre-selected web page element is a login or sign-in box, the user's login or sign-in information may be automatically filled (such as by an autofill function known in the art using stored user data such as username and password). The user is then enabled to more quickly access those other web pages linked in the original web page he/she frequently accesses without the need to download the entire first web page, scroll to the login box and then download the entire next (linked) web page.

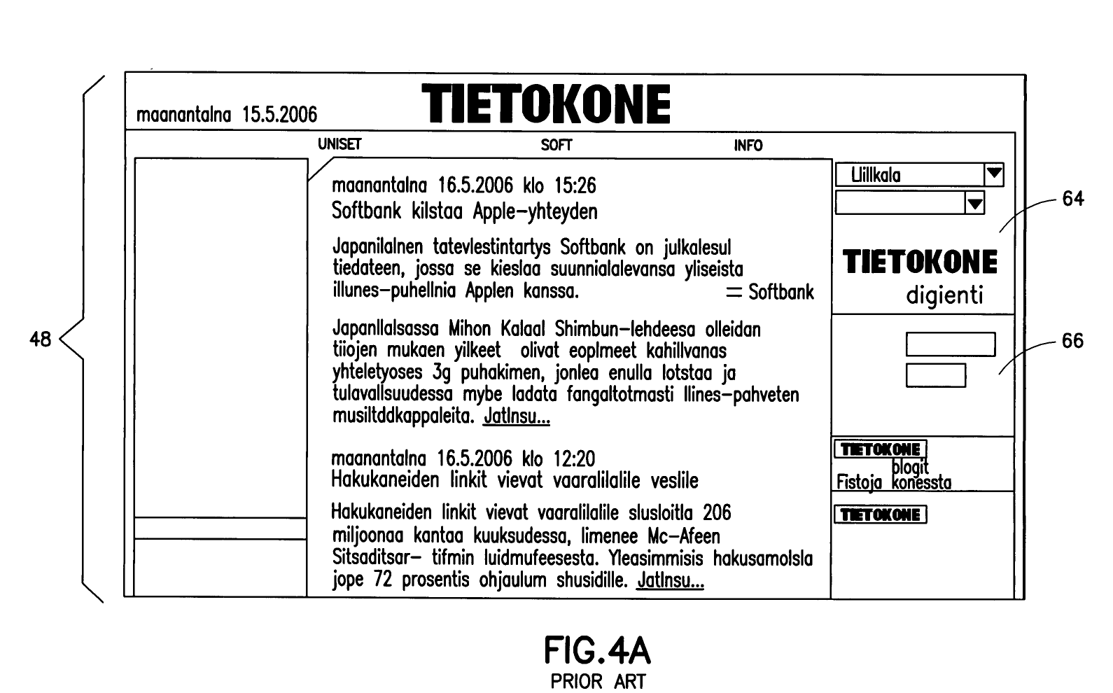

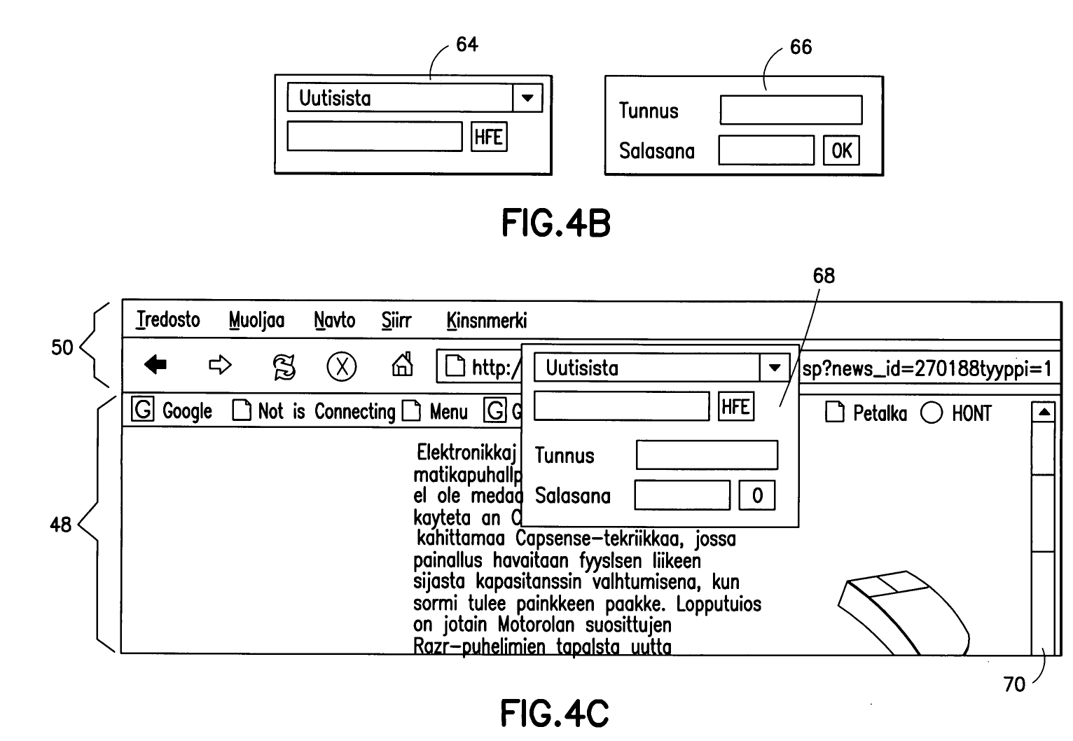

FIGS. 4A-4C illustrate an exemplary embodiment more particularly. FIG. 4A shows a “screen shot” of a returned web page as displayed according to the prior art. Two web page elements, 64 and 66, are identified and shown in isolation in FIG. 4B, a database selection menu 64 and a sign-in block 66. FIG. 4C shows a display of the web page 48 of FIG. 4A in relation to the toolbar 50 and the two elements 64, 66 of FIG. 4C combined into a contiguous block 68 of web page elements That is, the block 68, copied according to the teachings of this invention, represents the content of the menu 64 and sign-in block 66 but disposed in a different location than the original location as in the returned web page. Note that the elements 64, 66 as displayed on the returned web page 48 are not contiguous. In FIG. 4C, the contiguous block 68 is anchored to the toolbar 50, so that scrolling down on the returned web page using the scrollbar 70 does not move the contiguous block 68 of web page elements 64, 66 and therefore appears to a viewer as part of the toolbar 50. As shown in FIG. 4C, the embodiment creates a new browser menu item representing a web page element. Advantageously, that web page element is a login block, disposed in a new location different than its original location relative to the returned web page. Using an autofill function, the login data for the user is automatically copied into the web page elements at the new location, so that very few keystrokes are needed for login (e.g., eliminating choosing the login menu, choosing the correct form, entering the mobile device's master password, and only then auto filling the fields). The same result may be achieved by positioning the copied web page element 52 in spaced relation from the toolbar 50 so that the element 52 appears to ‘float’ as the web page 48 is scrolled. Alternatively, the copied web page element 52 may be anchored to a specific point on the web page (e.g., to another web page element) and scroll with the web page 48, and therefore appears to the viewer as a part of the returned web page.

The web page element therefore is disposed, on the display interface as viewed by a user, at a position different that the position dictated by the returned web page. Where the position of the web page element 64, 66 is considered a new position, the web page element 52, 64, 66 is still present and displayed in its original position of the returned web page when that portion of the returned web page can still be visible on the display interface. The latter may not always be the case such as where the web page requires scrolling to see other portions, or where a sign-in and further user action is required to view the element 52 as described with FIG. 3A. In an embodiment, the new position is within the web browser toolbar.

In one embodiment, the user may select which elements of a web page that are to be displayed in the new position, and the new position in which the element is to be displayed and whether it is anchored to the toolbar or to another element of the returned web page. This may be for example a software adjustment to the browser program, or an add-on software program that “piggybacks” on the browser program without altering that program itself (but merely alters the resulting display). In one embodiment, the user may pre-select a web page element 52, 64, 66 of a returned web page 48 by a right-click of a mouse and drag to an anchor point on the toolbar 50 or returned web page 48, setting the parameters so that the next time the browser program returns that same web page 48, the pre-selected element 52, 64, 66 is displayed in the new position. In this instance, the new position is associated in the mobile station's local memory only with that particular web page so that when the particular web page is invoked/downloaded, the pre-selected element is displayed in the new position. That same element is not copied into the new location when other web pages are retrieved, so there is a unique association in the local memory between a web page element and a particular web page from which the element is taken.

In another embodiment, the web page host may enable the above functionality by appending metadata to the web page that identifies one or more web page elements and anchor points (e.g., on the toolbar or on the web page itself) for them. When the appended web page is returned, the web browser (or piggyback program) reads the metadata, which identifies the web page element and anchor point/element, and displays as above without a specific selection of that same web page element by the user. Pages including metadata about different page items and elements could list those elements so that user could once select which of the items are added for example to menus automatically when page is loaded. User could for example select anchor to “sign in” so that next time when user loads the page, sign in element is shown as a floating item in a new position or as a menu item.

In certain web pages, the login box may be displayed in the prior art as a pop-up over another related web page, and that login box is typically not additionally disposed in the related web page. An example may be seen at www.one.com, the home page of a web hosting service. Once the home page is displayed, clicking on the “webmail” icon on that home page 49 results in a pop-up login box 51 displayed over the home page, as seen in FIG. 3B (though no browser toolbar is shown in FIG. 3B). This is typically referred to as framing, where the new web page 51 is “framed” within the web page 49 bearing the link that was used to call up the new web page, in the case of the www.one.com example, the login box. The fact that the new web page 51 is framed in the original 49 may not be so apparent in other embodiments of framing. Regardless, the framed page 51 is a part of the “returned” web page, despite being displayed alongside or over the original web page 49. In framing, the browser toolbar may be displayed only for the original page 49, as is the case with the www.one.com example though not shown in FIG. 3B.

In the framing environment, embodiments of this invention may copy the login box, which is present in the framed web page 51, to another location such as to lie within the browser toolbar or anywhere else on the display screen, that is different than that location it would be displayed as retrieved from the network. Where the login box is the entire framed web page 51, that entire framed web page 51 may be re-located to lie within or adjacent to the browser toolbar, or only a portion of it. In the framing environment, the browser program resident in the device may display the browser toolbar only with the original web page 49, and not additionally with the framed web page 51 as is the case with the example given above and with the majority of framing applications. Thus the copied login box or other web page element need not be restricted to the framed web page 51; the display of a web page element at a new, more convenient location on the display is the pertinent aspect. In accordance with an embodiment, the web element from a framed web page 51 may be displayed simultaneously with the browser toolbar and with a portion of the original web page 49. In this instance, the “retrieved” web page is the “original” web page 49 with the framed web page 51 in or over it.

Further to this aspect, the copied or re-located web element need not be retained in its original location on the retrieved web page as displayed to a user. For example, if the retrieved web page in the above framing embodiment is considered to be the combination of the original web page 49 that links to the framed page and the framed page 51 displayed over that original page, the entirely of the framed web page 51 need not be displayed; only that portion with the login box or other desired web element.

Broadening this aspect to the situation where there is no framing present in the retrieved web page, consider the case where the login box is copied to a convenient location (such as in the browser toolbar) from an original position that the user might otherwise need to scroll in order to view. In this aspect, the selected web element may be removed from that original position entirely since there is no need to display it twice in separate locations, regardless of whether or not scrolling is required to view the original position. In this aspect for the non-framing environment, the login box at the original position is deleted from that position according to this invention, and other content of the retrieved web page (one or more other web elements) is re-arranged to occupy that original position.

The advantages that may be gained by embodiments of this invention is that the user need not wait for an entire retrieved web page to load before a pre-selected (by the user or by the web page host) element or elements are displayed. For example, a sign in block that otherwise appears at the bottom of a scrollable retuned web page may be anchored to the toolbar or to another element near the top of the web page so that loading of the retrieved web page may be suspended and sign-in data entered more quickly than would otherwise be possible. For small display screens such as are present on many handheld portable devices, use of embodiments of this invention may prevent the need for scrolling on many of the user's favorite sites, particularly sites that require a login of registered users or search fields for a site-specific or general internet search engine (e.g., Google, Yahoo, etc.). To enable further speed where the communication link is not as robust as might be preferred, certain graphical elements may be pre-selected to display in accordance with this invention in only their text form or only with their text component, as text downloads much faster than graphics.

As can be appreciated, browser toolbars in the prior art are relatively unreflective of the content of a returned web page, except in certain instances such as when certain menu items are disabled (e.g., the forward button when there is no existing web page that was viewed subsequent to the currently displayed web page). Embodiments of this invention, where the element is anchored to the toolbar (either contiguous with it or spaced from it), mimic a toolbar that is dependent upon the content of the returned web page. Various adaptations to the above embodiments are then possible using this content-dependent toolbar feature, such as pre-selecting that any web page with a login element be displayed with that login element at a new position other than that original position in the returned web page.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, or as signaling formats, or by using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well-established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the exemplary embodiments of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method for displaying information comprising:
electronically retrieving a web page from a remote site with a web browser program;
simultaneously displaying on a graphical display interface:
a browser toolbar of menu items;
at least a portion of the retrieved web page; and
at least one pre-selected element of the web page at a new position different from an original position in which the pre-selected element exists in the retrieved web page.

2. The method of claim 1, wherein the pre-selected element is selected by a user of the web browser program prior to electronically retrieving.

3. The method of claim 1, wherein the pre-selected element is identified by metadata embedded in the retrieved web page.

4. The method of claim 1, wherein the new position is anchored to the displayed toolbar.

5. The method of claim 4, wherein the new position is spaced from the displayed toolbar.

6. The method of claim 1, wherein the new position is anchored to another element of the returned web page.

7. The method of claim 1, wherein the web page comprises an original web page in combination with another web page framed in the original web page, and the pre-selected element is of the another web page.

8. The method of claim 1, further comprising:
displaying another element of the web page at the original location, wherein the original location is displayed after scrolling.

9. A device comprising:
a memory for storing computer programs including a web browser program;
a processor coupled to the memory for executing instructions of said computer programs;
a graphical display interface coupled to the processor for displaying information; and
a communication link for coupling the device to the Internet;
wherein the web browser program and the processor operate to simultaneously display at the graphical display interface a browser toolbar of menu items; at least a portion of a web page retrieved from a remote site over the communication link; and at least one pre-selected element of the retrieved web page at a new position different from an original position in which the pre-selected element exists in the retrieved web page.

10. The device of claim 9, wherein the pre-selected element is selected by a user of the device and the selection is stored in the memory.

11. The device of claim 9, wherein the pre-selected element is identified by metadata embedded in the retrieved web page.

12. The device of claim 9, wherein the new position is anchored to the displayed toolbar.

13. The device of claim 11, wherein the new position is spaced from the displayed toolbar.

14. The device of claim 9, wherein the new position is anchored to another element of the returned web page.

15. The device of claim 9, wherein the communication link is wireless.

16. The device of claim 9 further comprising a portable power source coupled to the processor.

17. The device of claim 9, the retrieved web page comprises an original web page in combination with another web page framed in the original web page, and the pre-selected element is of the another web page

18. A program of machine-readable instructions, tangibly embodied on an information bearing medium and executable by a digital data processor, to perform actions directed toward displaying information to a user, the actions comprising:
electronically retrieving a web page from a remote site with a web browser program;
simultaneously displaying on a graphical display interface:
a browser toolbar of menu items;
at least a portion of the retrieved web page; and
at least one pre-selected element of the web page at a new position different from an original position in which the pre-selected element exists in the retrieved web page.

19. The program of claim 18, wherein the program enables a user to pre-select the element.

20. The program of claim 18, wherein the program identifies the pre-selected element from metadata embedded in the retrieved web page.

21. The program of claim 18, wherein the new position is anchored to one of the displayed toolbar or another element of the retrieved web page.

22. A device comprising:
memory means for storing computer programs including a page display program;
processor means coupled to the memory means for executing instructions of said computer programs;
graphical display means coupled to the processor means for displaying information; and
means for communicating with and means for coupling to a network;
wherein the page display program and the processor means operate to simultaneously display at the graphical display means at least a portion of an information page, retrieved from the network over the means for coupling, and at least one pre-selected element of the retrieved information page at a new position different from an original position in which the pre-selected element exists in the retrieved information page.

23. The device of claim 22, wherein:
the memory means comprises a computer readable storage medium;
the processor means comprises a digital data processor;
the graphical display means comprises one of a display screen and a data projector;
the means for communicating with a network comprises one of a transceiver and a modem; and
the means for coupling to a network comprises one of a wireless and a hardwired link.

24. A user interface comprising:
a graphical display interface for simultaneously displaying:
at least a portion of a web page received over a wireless communication link;
a browser toolbar from a local memory; and
an element of the received web page, displayed at a new position different than an original position in which the element is disposed in the received web page.

25. The method of claim 1, wherein the pre-selected element comprises a user login block.

26. The device of claim 9, wherein the pre-selected element comprises a user login block.
